(19) United States
(12) Patent Application Publication
(10) Pub. No.: US 2025/0391034 A1
(43) Pub. Date: Dec. 25, 2025

(54) SYSTEM AND METHOD FOR DETECTING AN OBJECT

(71) Applicant: The University of Hong Kong, Pokfulam (HK)

(72) Inventors: Yaping Zhao, Hong Kong (CN); Edmund Yin Mun Lam, Kwai Chung (CN)

(21) Appl. No.: 19/242,039

(22) Filed: Jun. 18, 2025

Related U.S. Application Data
(60) Provisional application No. 63/662,526, filed on Jun. 21, 2024.

(51) Int. Cl. G06T 7/207; G06T 7/246

(52) U.S. Cl. CPC G06T 7/207; G06T 7/251; G06T 2207/10004; G06T 2207/10016; G06T 2207/20081

(57) ABSTRACT

A system for detecting an object from an image includes: a computing apparatus having a processing unit, a memory unit and a user interface, the processing unit operatively coupled to the memory unit, the computing apparatus configured to: compress optical signals (i.e., visual signals) from a real world scene using a Snapshot Compressive Imaging (SCI) system to obtain compressed signals, receive the compressed signals, store the compressed signals as compressed images, apply one or more knowledge distillation techniques in conjunction with a pre trained object detection model to detect one or more objects directly from each compressed image, utilize motion information encoded within the compressed data to optimize the object detection process, and present on the user interface the one or more detected objects on an image.

### TECHNICAL FIELD

The invention relates to a system and method for detecting an object, in particular but not limited to a system and method for detecting an object from a video stream or one or more images.

### BACKGROUND

Object detection in images and video is a problem that to which various approaches have been applied.

Snapshot compressive imaging (SCI) is a technique that marries the principles of compressive sensing with traditional imaging to enable efficient optical signal compression and acquisition. SCI approach has been used in object detection. Despite its advancements, SCI has not fully embraced the integration with downstream tasks, particularly object detection, a crucial task in the field of artificial intelligence (AI) that involves accurately identifying and localizing objects or events within complex dynamic scenes.

Traditional approaches for object detection generally follow a sequential workflow of capture, compression, reconstruction and detection. This can be quite resource intensive and slow.

### SUMMARY OF THE INVENTION

In accordance with a first aspect, there is provided a system for detecting an object from an image comprising:
a computing apparatus comprising a processing unit, a memory unit and a user interface, the processing unit operatively coupled to the memory unit,
the computing apparatus is configured to:
   receive one or more images of a real-world scene,
   compress the one or more received images to obtain one or more compressed images,
   detect one or more objects in each compressed image,
   present the one or more detected objects on a user interface.

In one example the computing apparatus is configured to capture images using a snapshot compressive imaging (SCI) system, wherein the SCI system is configured to capture images and compress the images to generate the one or more compressed images.

In one example the computing apparatus is adapted to perform an object detection process directly on the compressed images to detect the one or more objects.

In one example the computing apparatus comprises an object detection model stored therein, wherein the computing apparatus is configured to apply the object detection model to the received images as part of the object detection process.

In one example the object detection model comprises a backbone feature module and a task loss module and feature loss module.

In one example the system comprises a camera, and the computing apparatus is configured to compress the received images using a snapshot compressive imaging system.

In one example the computing apparatus is configured to encode the received images by temporally varying masks as part of compressing the one or more received images.

In one example the object detection model comprises a pre trained YOLO model.

In one example the object detection model comprises an encoder, convolution layers, a backbone feature, neck and head, wherein neck and head output an image with detected objects identified thereon.

In one example the object detection model is trained using a knowledge distillation process executed by the computing apparatus.

In one example computing apparatus is configured to, as part of the knowledge distillation process:
build a teacher model configured to extract and utilize visual information from ground truth images or videos,
guide a student model using the teacher model to train the student model to detect objects, wherein the student model is the object detection model, and;
wherein the teacher model and the student model are adapted to utilize a combined feature loss and task loss.

In one example the one or more images are still images or frames of a video stream.

In one example the computing apparatus is adapted to apply a Bayer filter to each of the received images following temporally masking the received images.

In one example snapshot compressive imaging system comprises a masking module and a filtering module, the masking module configured to apply one or more temporal masks to each of the received images and the filtering module is adapted to apply a Bayer filter to each of the masked images.

According to a further aspect, there is provided a computer-implemented method for detecting an object from an image comprising:
receiving one or more images of a real-world scene,
compressing the one or more received images to obtain one or more compressed images,
detecting one or more objects in each compressed image.

In one example the one or more objects are detected by performing an object detection process directly on the one or more compressed images.

In one example the object detection process is performed by an object detection model, wherein the object detection model comprises a backbone feature module and a combined feature and task loss.

In one example the step of compressing comprises processing the received images using a snapshot compressive imaging.

In one example the step of compressing the one or more images comprises encoding the received images temporally varying masks.

In one example the object detection model comprises a pre trained YOLO model.

In one example the object detection model comprises an encoder, convolution layers, a backbone feature, neck and head, wherein neck and head output an image with detected objects identified thereon.

In one example the object detection model is trained using a knowledge distillation process.

In one example the knowledge distillation process comprises the steps of:
building a teacher model configured to extract and utilize visual information from ground truth images or videos,
guiding a student model using the teacher model to train the student model to detect objects, wherein the student model is the object detection model, and;
wherein the teacher model and the student model are adapted to utilize a combined feature loss and task loss.

In one example the method comprises the step of presenting the one or more detected objects on a user interface.

In one example the one or more images are still images or frames of a video stream.

According to a further aspect, there is provided a data processing system comprising means for carrying out the method of any one of statements above.

According to a further aspect, there is provided a computer program comprising instructions which, when the program is executed by a processing unit, cause the computing apparatus to carry out the method of any one of the statements above.

According to a further aspect there is provided a computer-readable medium comprising instructions which, when executed by a processing unit, cause the computing apparatus to carry out the method of any one of the statements above.

According to a further aspect, there is provided a system for detecting an object from an image comprising:
a computing apparatus comprising a processing unit, a memory unit and a user interface, the processing unit operatively coupled to the memory unit,
the computing apparatus is configured to:
   compress one or more received optical signals (i.e., visual signals) from a real world scene to generate compressed signals,
   receive and store the compressed signals as compressed images,
   detect one or more objects in each compressed image,
   present the one or more detected objects on the user interface.

In one example, the one or more objects are detected directly in each compressed image. In this example, the one or more objects are detected in each compressed image without first decompressing or reconstructing the images.

In one example, the computing apparatus is adapted to utilise a snapshot compressive imaging (SCI) system to compress one more received optical signals and generate compressed signals.

In one example, computing apparatus is configured to employ one or more knowledge distillation techniques in addition to a pre trained object detection model to detect one or more objects directly in each compressed image.

According to a further aspect, there is provided a system for detecting an object from an image comprising:
a computing apparatus comprising a processing unit, a memory unit and a user interface, the processing unit operatively coupled to the memory unit,
the computing apparatus is configured to:
   compress optical signals (i.e., visual signals) from a real world scene using a Snapshot Compressive Imaging (SCI) system to obtain compressed signals,
   receive the compressed signals
   store the compressed signals as compressed images,
   apply one or more knowledge distillation techniques in conjunction with a pre trained object detection model to detect one or more objects directly from each compressed image,
   utilise motion information encoded within the compressed data to optimise the object detection process,
   present on the user interface the one or more detected objects on an image.

In one example the computing apparatus is configured to capture images using a snapshot compressive imaging (SCI) system, wherein the SCI system is configured to capture images and compress the images to generate the one or more compressed images.

In one example, the computing apparatus may be configured to apply an object detection model. The object detection model may be trained using the knowledge distillation process in conjunction with a pre trained model. The pre trained model may operate as a teacher model to train the object detection model.

According to a further aspect, there is provided a method employing a combination of feature loss and task loss in the training strategy of the detection model, which is specifically tailored to enhance the performance of object detection algorithms that work directly with compressed optical measurements. This training strategy substantially improves the efficiency and accuracy of the detection process, aligning it with real-time application requirements and overcoming limitations associated with traditional methods that require decompression or reconstruction of data before detection can occur.

According to a further aspect, there is provided a method for detecting an object comprising the steps of:
receiving one or more images of a real-world scene,
compressing the one or more received images to obtain one or more compressed images, wherein compressing comprises applying a snapshot compressive imaging (SCI) system to compress the received images,
wherein compressing the images further comprises encoding the received images by temporally varying masks,
detecting one or more objects directly in each compressed image,
presenting the one or more detected objects on a user interface,
wherein detecting one or more objects comprises applying an object detection model to the received images, wherein the object detection model comprises a backbone feature module and a task loss module and feature loss module, wherein the object detection model is a pretrained YOLO model, and wherein the YOLO model is pretrained to detect objects directly in each compressed image.

The term “comprising” (and its grammatical variations) as used herein are used in the inclusive sense of “having” or “including” and not in the sense of “consisting only of”.

The term “image” as used herein refers to a still image or a frame of a video stream. The received images may be single still images or a video stream and frames of the received video stream.

It is to be understood that, if any prior art information is referred to herein, such reference does not constitute an admission that the information forms a part of the common general knowledge in the art, in any country.

### BRIEF DESCRIPTION OF THE DRAWINGS

Embodiments of the present invention will now be described, by way of example, with reference to the accompanying drawings in which:

FIG. 1 illustrates two common processes employed for object detection. These processes are known processes.

FIG. 2 illustrates a system for detecting an object from an image.

FIG. 3 illustrates a schematic diagram of a computing apparatus used as part of the system of FIG. 2.

FIG. 4 illustrates an example method for detecting an object from an image.

FIG. 5 illustrates a further example method for detecting an object from an image.

FIG. 6 illustrates a method for detecting an object from an image in comparison with the two common processes shown in FIG. 1.

FIG. 7 illustrates an video SCI system that is part of the system for detecting an object.

FIG. 8 illustrates an example architecture of an object detection model used as part of the system and method for object detection.

FIG. 9 illustrates an example of knowledge distillation process using a teacher model and a student model.

FIG. 10 illustrates qualitative results on the BD100K dataset of various object detection methods.

FIG. 11 illustrates qualitative results on the AAU RainSnow dataset of various object detection methods.

FIG. 12 illustrates qualitative results on the MOT dataset of various object detection methods.

FIG. 13 illustrates qualitative results on the VIRAT dataset of various object detection methods.

FIG. 14 shows qualitative results on the DAVIS dataset of various object detection methods. FIG. 14 illustrates the comparative test of the present invention and other object detection methods on sports videos.

FIG. 15 illustrates qualitative results on the Vimeo90K dataset. FIG. 15 shows comparative performance on animal videos.

FIG. 16 illustrates a graph of a comparison of the system and method for objection detection in accordance with the present invention and other object detection methods. The graph in FIG. 16 illustrates comparisons of inference time and average precision among objection detection methods using SCI.

FIG. 17 illustrates an example block diagram of an alternate example of a method for detecting objects.

### DETAILED DESCRIPTION OF THE PREFERRED EMBODIMENTS

Object detection from images e.g., still images or video streams or frames of videos is a common function that is performed. Object detection is used in many applications such as for example, traffic management, autonomous driving, surveillance and many other applications. Object detection is challenging, time consuming and resource intensive. AI models have been applied for solving the task of object detection.

Traditional object detection models follow a sequential process of optical measurement (i.e., image capture), optical signal compression, reconstruction and then subsequent AI tasks such as object detection. These traditional approaches can be slow and resource intensive and often not well optimised for object detection.

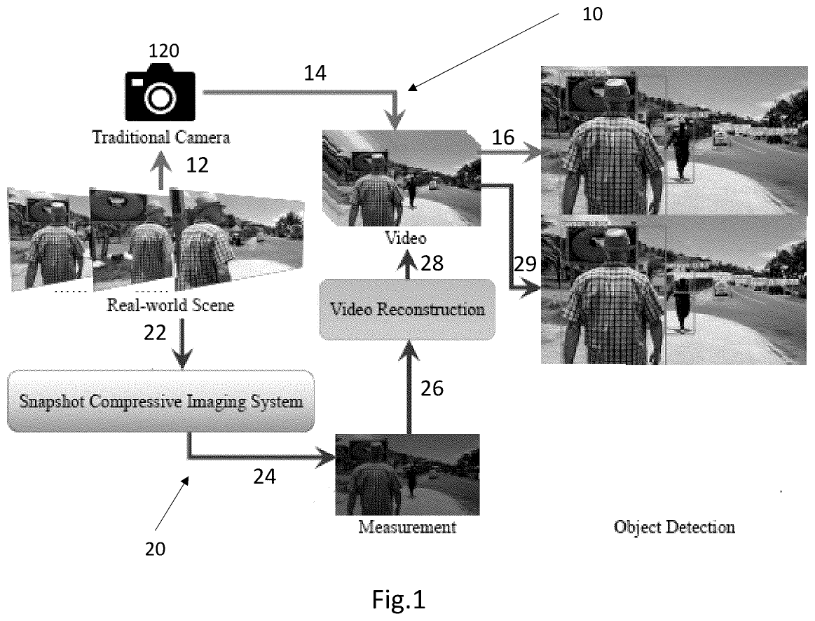

FIG. 1 illustrates two common processes for object detection, method 10 and method 20. Method 10 comprises steps 12, 14, 16 that illustrate traditional object detection method. This method requires capturing and detecting each video frame at step 12 and 14, respectively. Step 16 comprises performing object detection on each frame sequentially. This traditional approach 10 can be time consuming, consume large amounts of storage and computational resources and can result in less motion capture detail due to limited frame rates.

Referring to FIG. 1, a two-stage approach for object detection 20 is illustrated. The process 20 comprises steps 22, 24, 26, 28 and 29. The two-stage approach uses Snapshot Compressive Imaging (SCI) to efficiently capture high speed objects. SCI involves sampling optical signals with an advanced imaging system to obtain compressed measurements at step 22 and 24, respectively. Step 26 comprises reconstruction of the video frames from the SCI measurements. Step 28 comprises feeding the reconstructed video into an object detection model. Step 29 comprises performing object detection and outputting the results. This two-stage method 20, although is efficient at capturing high speed objects, has limitations such as the need for intensive computing resources for reconstruction and the results quality being heavily dependent on the quality of the reconstruction. Again, the two-stage method 20 can be slow, resource intensive and can result in reduced accuracy.

The present invention relates to a system and method for detecting an object from a video stream or one or more images. The present invention provides an improved object detection method and a system that provides improved object detection. The object detection method of the present invention directly performs object detection on compressed images (i.e., compressed measurements).

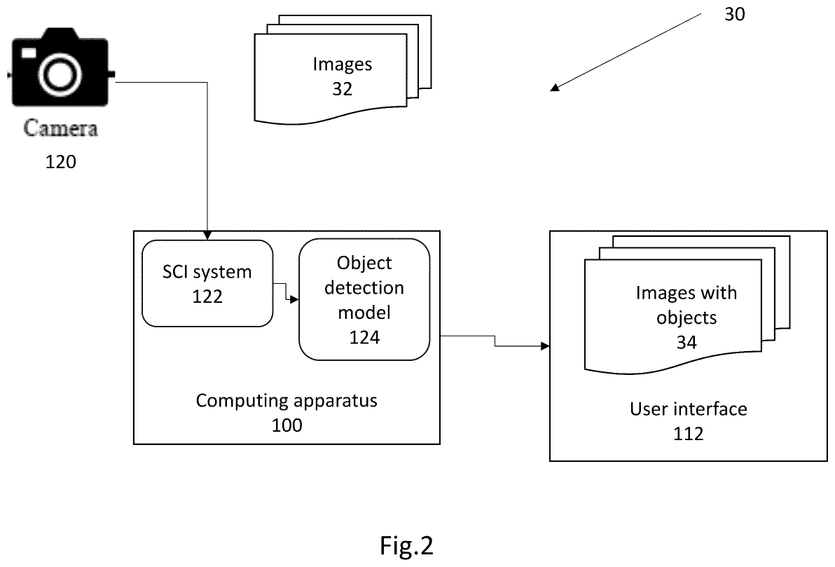

Referring to FIG. 2, an embodiment of the present invention is illustrated. This embodiment is arranged to provide a system for detecting an object from an image 30 that provides an improved object detection comprising: a computing apparatus 100 comprising a processing unit 102, a memory unit 104 and a user interface 112, the processing unit operatively coupled to the memory unit, the computing apparatus is configured to: receive one or more images of a real world scene, compress the one or more received images to obtain one or more compressed images, detect one or more objects in each compressed image (e.g., each video frame) and present the one or more detected objects on a user interface 112. The images with objects identified 34 therein may be presented on the user interface 112.

The computing apparatus 100 may be adapted to perform an object detection process directly on the compressed images to detect the one or more objects. The computing apparatus may comprise an object detection model stored therein, wherein the computing apparatus is configured to apply the object detection model to the received images as part of the object detection process.

The images with identified objects 34 may be presented as still images. Alternatively, the images with identified objects 34 may be presented as a video stream with objects identified in each frame. The video stream 34 with identified objects may be displayed on the user interface 112 or may be transmitted to another system or another device e.g., a tablet, smartphone or server etc.

The compressed images may comprise motion information for each object. The motion information may be utilized by the object detection model to calculate movement of identified objects through multiple frames. The motion or movement of objects through multiple frames can be calculated by the computing apparatus using the object detection model 124. In this manner identified objects can be tracked through a video stream or through multiple frames.

The system 30 further comprises a camera 120 (or other image capture device). The computing apparatus 100 is adapted to communicate with the camera 120. The camera 120 may be a smartphone or a digital camera or other suitable device to capture one or more digital images of the object. The images are transmitted from the camera 120 to the computing apparatus 100. In one example the camera 120 may be a video camera that is adapted to capture a video stream of a real world stream. The video camera 120 may be a digital video camera.

The system 30 further comprises a SCI system 122. The SCI system 122 is configured to compress captured images. In one example, the SCI system 122 may be configured to capture images and compress the captured images to obtain compressed images (i.e., compressed images). The SCI system 122 is adapted to efficiently capture images of objects. The system 30 further comprises an object detection model 124. The object detection model 124 may be arranged in digital communication with the SCI system 122. The object detection model 124 is configured to perform object detection directly on the compressed images. In one example, the object detection model may be a pre-trained YOLO model.

As further explanation the SCI system 122 is adapted to receive optical signals (i.e., visual signals) of a real world. The SCI system 122 is further adapted to compress the optical signals of the real world scene to generate compressed signals. The compressed signals are stored within a memory unit as compressed images.

In one example, the SCI system may include one or more SCI cameras that are configured to capture images and compress images.

In one example embodiment, the SCI system 122 may be stored on the computing apparatus 100 and executed by the computing apparatus 100. For example, the processing unit 102 may be configured to utilise the SCI system 122 to compress the captured images. The processing unit 102 may be configured to execute the object detection model 124. The detection model 124 is adapted to detect one or more objects directly within the compressed images. This framework deviates from traditional methods by eliminating the sequential workflow of capture, compression, reconstruction, and detection. The model 124 directly detects objects in the compressed images, which enhances efficiency by reducing the time, storage, and computational demands associated with object detection tasks

The object detection model 124 may be configured to apply a knowledge distillation technique in conjunction with a pre-trained object detection model to detect one or more objects directly from each compressed image. The object detection model 124 may utilise one or more knowledge distillation techniques in conjunction with a pre trained object detection model. The pre trained model may be utilised to train the object detection model 124 e.g., using a teacher and student approach. In one optional example the teacher model may also be stored in the computing apparatus.

This approach improves the accuracy of object detection and does so by effectively utilizing the motion information encoded within the compressed data. This method represents an enhancement over traditional detection systems, which generally rely on decompression or reconstruction of data prior to detection.

In one example embodiment, the computing apparatus 100 (i.e., computer or computing device or processing device or computer system) may be implemented by any computing architecture, including portable computers, tablet computers, stand-alone Personal Computers (PCs), smart devices, Internet of Things (IOT) devices, edge computing devices, client/server architecture, “dumb” terminal/mainframe architecture, cloud-computing based architecture, or any other appropriate architecture. The computing device may be appropriately programmed to implement the invention.

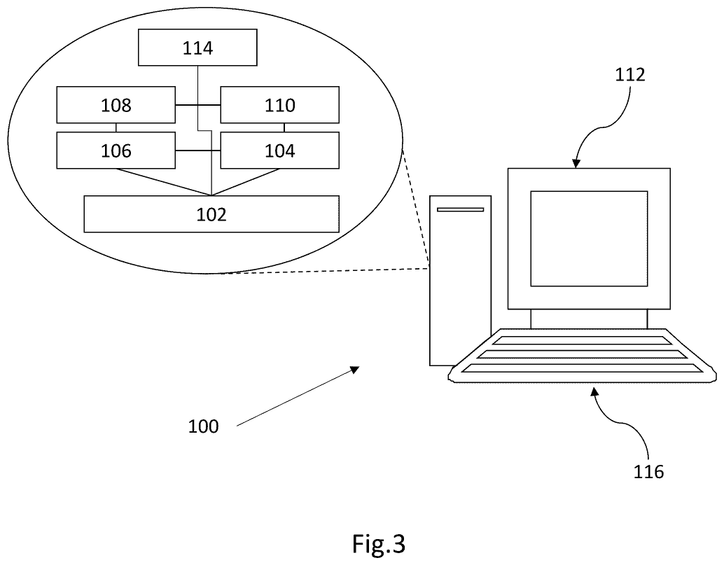

Referring to FIG. 3, there is a shown a schematic diagram of a computing apparatus or computer server 100 which is arranged to be implemented as an example embodiment of a system for estimating a local shape of a point on an object e.g., a human face. In this embodiment system comprises a computing apparatus 100 which includes suitable components necessary to receive, store and execute appropriate computer instructions. The components may include a processing unit 102, including Central Processing Unit (CPU), Math Co-Processing Unit (Math Processor), Graphic Processing Unit (GPUs) or Tensor processing unit (TPUs) for tensor or multi-dimensional array calculations or manipulation operations, one or more memory units such as for example a read-only memory (ROM) 104 and a random-access memory (RAM) 106. The computing apparatus 100 comprises input/output devices such as disk drives 108, input devices 110 such as an Ethernet port, a USB port, etc.

The computing apparatus comprises a user interface 112. The user interface may comprise a display 112 such as a liquid crystal display, a light emitting display or any other suitable display and optionally a keypad 116 or other elements to allow a user to input instructions. The user interface 112 may comprise a touchscreen. The computing apparatus 100 comprises one or more communications links 114.

The computing apparatus 100 may include instructions that may be included in ROM 104, RAM 106 or disk drives 108 and may be executed by the processing unit 102. There may be provided a plurality of communication links 114 which may variously connect to one or more computing devices such as a server, personal computers, terminals, wireless or handheld computing devices, Internet of Things (IoT) devices, smart devices, edge computing devices. At least one of a plurality of communications link may be connected to an external computing network through a telephone line or other type of communications link. The computing apparatus 100 may be configured to communicate with the camera 120 or the user interface 112 or other components using a suitable communication protocol such as for example 4G or 5G or Wi-Fi or other suitable communications networks.

The computing apparatus 100 may include storage devices such as a disk drive 108 which may encompass solid state drives, hard disk drives, optical drives, magnetic tape drives or remote or cloud-based storage devices. The computing apparatus 100 may use a single disk drive or multiple disk drives, or a remote storage service. The server 100 may also have a suitable operating system which resides on the disk drive or in the ROM of the apparatus 100.

The computer or computing apparatus 100 may also provide the necessary computational capabilities to operate or to interface with a machine learning network, such as a neural networks, to provide various functions and outputs. The neural network may be implemented locally, or it may also be accessible or partially accessible via a server or cloud-based service. The machine learning network may also be untrained, partially trained or fully trained, and/or may also be retrained, adapted or updated over time. The computing apparatus 100 comprises computational capabilities to execute one or more object detection models. The computing apparatus 100 may further comprise computational capabilities to execute an SCI system.

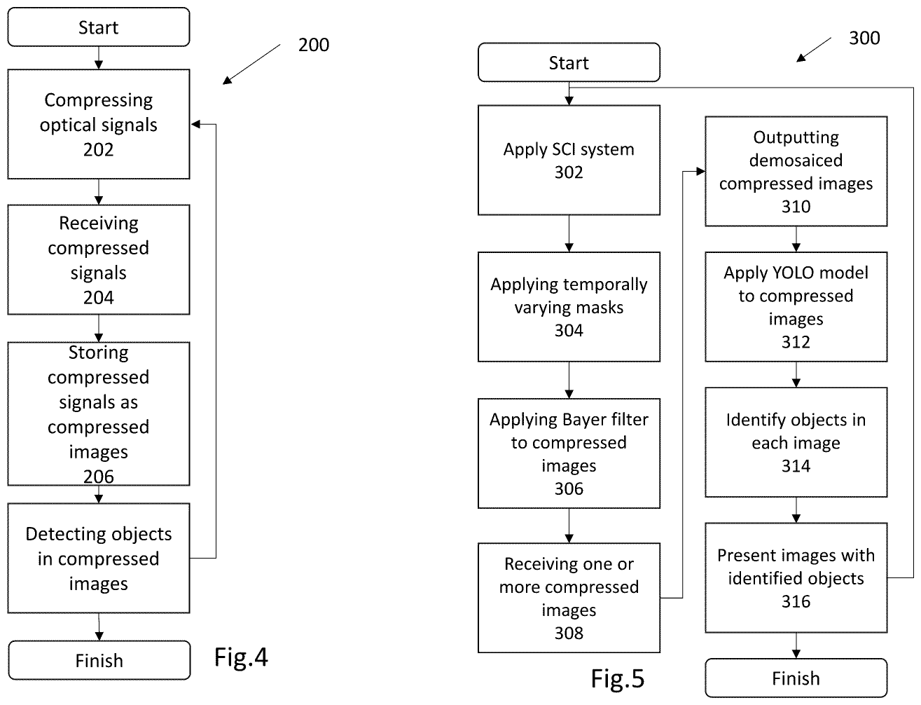

FIG. 4 illustrates a computer-implemented method for detecting one or more objects 200. The method 200 may be adapted for detecting one or more objects in still images or in a video stream. The method 200 commences at step 202. Step 202 comprises compressing optical signals of a real world scene. The optical signals may be captured by an appropriate optical signal (i.e., visual signals) by an optical device such as for example a camera or via an SCI system.

Step 204 comprises receiving the compressed optical signals. The signals may be received by the processor. Step 206 comprises storing the compressed signals as compressed images. The compressed images may be stored in a memory unit.

Step 208 comprises detecting objects in the compressed images. The objects are detected directly in the compressed images. An object detection model may be applied to the compressed images to detect objects in the compressed images.

The method may comprise the additional step of presenting the detected objects on a user interface. The detected objects may be identified e.g., by a border or frame on the images, and the images with the identified objects may be presented on a user interface. The one or more objects are detected by performing an object detection process directly on the one or more compressed images. The method 200 may be repeated continuously.

The method 200 may be stored as computer readable and executable instructions on a memory unit of the computing apparatus. The instructions may be executed by the processing unit 102 to cause the computing apparatus 100 to perform the steps of method 200.

An alternative example method of detecting objects in an image may comprise the steps of receiving one or more images of a real-world scene, compressing the one or more received images to obtain one or more compressed images, detecting one or more objects in each compressed image (or frame) and presenting the detected objects on a user interface. One or more images illustrating the detected objects may be displayed on the user interface. The method may be stored as computer readable and executable instructions. The instructions may be executed by the processing unit to cause the computing apparatus to perform the steps described above.

FIG. 5 illustrates a further example method 300 for detecting one or more objects from one or more images, in particular from a video stream. Step 302 comprises Applying an SCI system compress optical signals (i.e., visual signals). Optionally, the SCI system may generate compressed images. In one example form, the SCI system may be used to sample images or frames from a received video stream. The SCI system may also be used to compress the received images receiving one or more images.

Step 304 comprises applying temporally varying masks to the received optical signals (i.e., visual signals). The optical signals may comprise images. Applying the temporally varying cases encodes the signals or images with the masks. The temporally varying masks may be applied by the SCI system or by a processing unit of the computing apparatus.

Step 306 comprises applying a Bayer Filter after the application of the temporally varying masks. The Bayer Filter application may generate demosaiced compressed images. The demosaicing process reconstructs the colors within the compressed images by applying the Bayer Filter. Step 306 may be an optional step.

Step 308 comprises receiving the one or more compressed images. The compressed images may be stored in a memory unit.

Step 310 comprises outputting demosaiced compressed images. The demosaiced compressed images may include one or more reconstructed colours within the compressed images.

Step 312 comprises identifying one or more objects in each compressed image by using the pre trained YOLO model. The pre trained YOLO model may be trained using a knowledge distillation process. The knowledge distillation process may implement a pre trained YOLO model that functions as a teacher model and the current object detection model (YOLO model) may operate as a student model with combined feature loss and task loss.

Step 314 comprises presenting the identified objects in each image on a UI. The images may be presented on the UI with each identified objected highlighted e.g., by a frame or color on each of the images. The method 300 may be repeated continuously in the computing apparatus.

In one example, the data processing system 30 may comprise a means for carrying out the method 200 or method 300 as described above. In a further example the computing apparatus may include a computer program comprising instructions which, when the program is executed by a processing unit of the computing apparatus, cause the computing apparatus 100 to carry out the method 200 or method 300 as described above. In a further example, the computing apparatus may comprise a computer-readable medium comprising instructions which, when executed by a processing unit, cause the computing apparatus to carry out the method 200 or method 300 as described earlier. The methods 200 and 300 may be used to continuously process received video streams to identify objects in each frame of the video stream.

The method 200 or method 300 may be applied for various use cases such as for example, autonomous driving, security and surveillance, traffic management, sports analytics or animal monitoring.

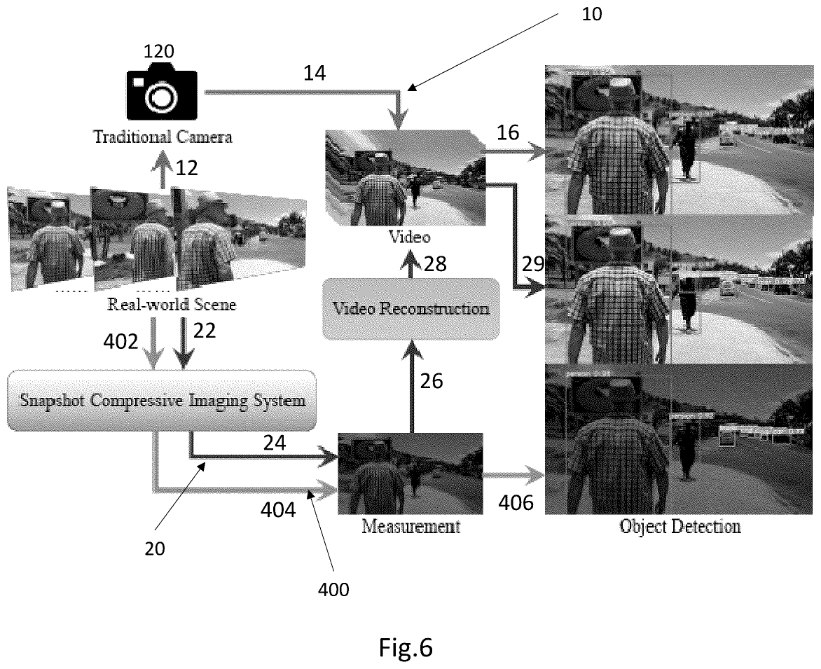

Referring to FIG. 6 there is shown an example implementation of a method 400 for detecting an object in one or more images, in particular for object detection in a video stream. The method 400 shown in FIG. 6, is a high-level illustration of the implementation of method 200 or 300. The methods 200 and 300 show the details of each method. FIG. 6 shows a comparison of the object detection method according to the present invention with two known methods 10, 20.

Referring to FIG. 6, the method captures a video stream of a real-world scene at step 402. Step 404 comprises using a SCI system to compress the images. Step 406 comprises performing object detection directly on the compressed images i.e., on the compressed measurements. The images with the objects may be presented as shown in FIG. 6. The method 400 (and methods 200, 300) directly detect objects in the compressed images (i.e., compressed optical measurements), which reduces time, storage and computation resources. The method 200, 300 and 400 also fully utilize the motion information within the compressed measurements to enhance accuracy of the object detection.

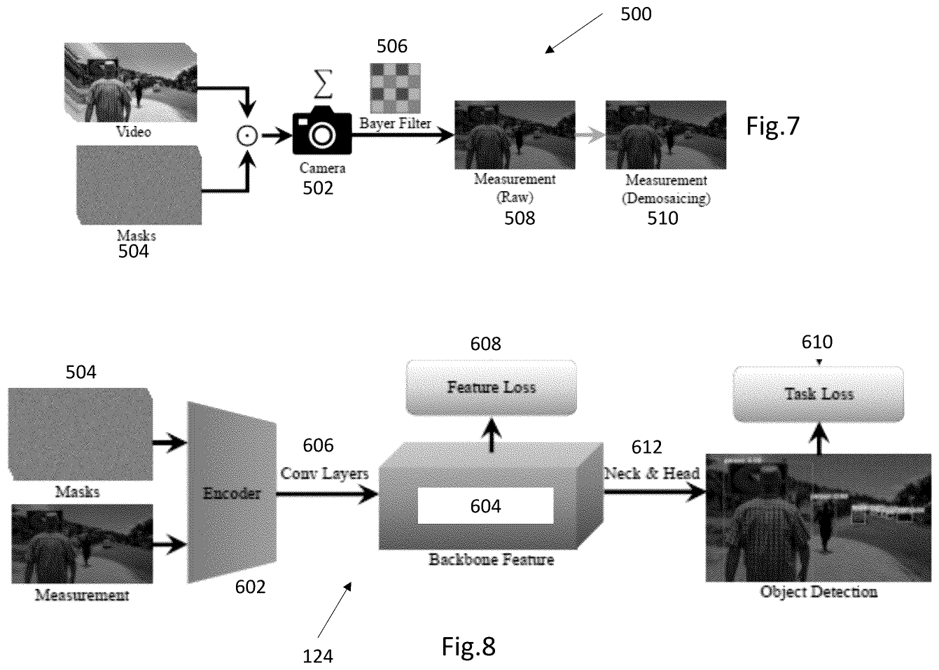

Aiming at the efficient and effective optical signal acquisition, SCI systems leverage optical designs for sampling data as compressed measurements. FIG. 7 illustrates a video SCI system 500. In the illustrated embodiment of FIG. 7, the video SCI system 500 uses a low speed camera 502 to capture high-speed scenes, where the optical signals are encoded using temporally varying masks 504 to generate raw measurements 508. Therefore, the compressed optical measurement could be modelled as:

$$Y = {\sum }_{n = 1}^{B} {X}_{n} ⊙ {Φ}_{n} + E \qquad ( 1 )$$

where Y∈R^{H×W} is the compressed measurement of B frames {Xn∈R^{H×W}} Bn₌₁, modulated by B coding masks {ϕn∈R^{H×W}} Bn₌₁; ⊙ is the Hadamard product and E∈R^{H×W} is the noise.

A Bayer Filter 506 can be applied to the raw measurements 508 to demosaic the raw results. The output from the application of the Bayer Filter 506 comprises demosaiced measurements 510. The demosaiced measurements are compressed measurements.

FIG. 8 illustrates an example architecture of an object detection model 124 that is used to process the compressed images i.e., compressed measurements directly to identify objects in the compressed images. The model 124 may comprise an encoder 602. The encoder encodes the images with the masks 504. The model 124 further comprises a backbone feature 604 with convolution layers 606 between the encoder 602 and the backbone feature 604. The model 124 further comprises a feature loss module 608 and a task loss module 610. A model neck and head 612 is downstream of the backbone feature 604. In one example, the model 124 may be a trained YOLO model.

Traditionally to perform object detection, a straightforward method is to train a detector and then process the video frame-by-frame. This traditional method consumes substantial time, storage, and computational resources, while the frame rates of traditional cameras are quite limited, restricting the ability to capture detailed motion information of objects. In contrast, the video SCI approach of the present invention overcomes these limitations, although direct object detection on compressed, blurry, and noisy measurements poses challenges. To tackle these problems, a knowledge distillation process is used to train the model 124. The knowledge distillation process utilises a pre-trained YOLO model and optimize training with a combined feature and task loss.

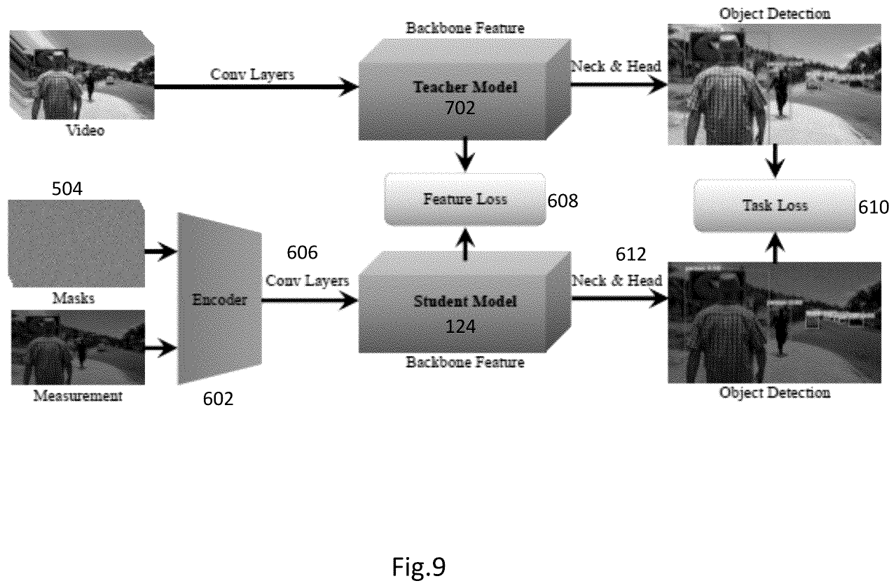

Leveraging equation 1 (above), numerous video-measurement pairs are simulated for knowledge distillation from video to measurement. As shown in FIG. 9 a teacher model 702 is built. The teacher model 702 that extracts and utilizes visual information from ground-truth videos to guide the feature extraction from compressed measurements. Specifically, the teacher model 702 uses a pre-trained YOLO as the teacher model and a knowledge distillation process is utilised to guide the student model 124. FIG. 9 illustrates an example knowledge distillation process.

The student model 124 may have an architecture that is almost identical to the teacher model 702. The student model 124 comprises an additional encoder for data dimension compatibility.

As part of the knowledge distillation the backbone feature is denoted as A∈R^{H×W×C}, where H, W, C denotes its height, width, and channel number, respectively. Then, generating spatial and channel attention maps involves mapping functions:

$${𝒢}^{p} : {ℝ}^{H \times W \times C} \to {ℝ}^{H \times W} and {𝒢}^{c} : {ℝ}^{H \times W \times C} \to {ℝ}^{C} respectively ,$$

with the superscripts p and c to discriminate ‘spatial’ and ‘channel’:

$${𝒢}^{p} ( A ) = \frac{1}{C} {\sum }_{k = 1}^{C} \vert {A}_{\cdot , \cdot , k} \vert , {𝒢}^{c} ( A ) = \frac{1}{HW} {\sum }_{i = 1}^{H} {\sum }_{j = 1}^{W} \vert {A}_{i , k , \cdot } \vert , \qquad ( 2 )$$

where i, j, k denotes the iₜₕ, jₜₕ, kₜₕ slice of A in the height, width, and channel dimension, respectively. Then, the spatial attention mask M^{ρ} and the channel attention mask M^{c} used in knowledge distillation can be obtained by integrating attention from both models (teacher and student) as:

$${M}^{p} = HW \cdot softmax ( ( {𝒢}^{p} ( {A}^{s} ) + {𝒢}^{p} ( {A}^{t} ) ) / T ) , {M}^{c} = C \cdot softmax ( ( {𝒢}^{c} ( {A}^{s} ) + {𝒢}^{c} ( {A}^{t} ) ) / T ) , \qquad ( 3 )$$

where s and t differentiate student and teacher models, and T adjusts attention mask distribution.

The feature loss, [symbol] _{f} combines attention transfer loss [symbol] ₐₜ and attention-masked loss [symbol] ₐₘ to align the attention and features of the student model 124 with the teacher model 702, using:

$${ℒ}_{at} = {ℒ}_{2} ( {𝒢}^{p} ( {A}^{s} ) + {𝒢}^{p} ( {A}^{t} ) ) + {ℒ}_{2} ( {𝒢}^{c} ( {A}^{s} ) + {𝒢}^{c} ( {A}^{t} ) ) . \qquad ( 4 )$$

[symbol] ₐₘ is utilized to encourage the student to mimic the features of teacher models by a [symbol] ₂ norm loss masked by M^{s} and M^{c}, which can be formulated as

$${ℒ}_{am} = ( {\sum }_{i = 1}^{H} {\sum }_{j = 1}^{W} {\sum }_{k = 1}^{C} {( {A}_{i , j , k}^{t} - {( {A}_{i , j , k}^{s} )}^{2} \cdot {M}_{i , j}^{p} \cdot {M}_{k}^{c} )}^{\frac{1}{2}} \qquad ( 5 )$$

The student model is trained end-to-end, with the total loss [symbol] = [symbol] _{d}+α [symbol] _{f}, where [symbol] _{d} is the task loss for detection model, α is the hyper-parameter to balance different distillation losses. The above knowledge distillation process results in a trained student model 124 that can be utilised as part of the system 30 and method for detecting objects from compressed images.

FIG. 9 illustrates an improved training strategy that is utilised as part of the object detection system and method. The training strategy includes a unique combination of feature loss and task loss. This strategy is specifically designed to boost the performance of object detection algorithms that operate directly on compressed optical measurements. This represents an advancement over existing methods, offering a more efficient and direct approach to object detection without the need for data decompression or reconstruction.

The proposed system and method for object detection in accordance with the present invention was tested by the inventors. The method of object detection was compared against various algorithms across six diverse datasets, using a comprehensive set of evaluation metrics to close the gap between laboratory testing and real-world applicability. The datasets span a wide array of scenarios: (a) BDD100K, featuring real driving videos from drivers' perspective within vehicles; (b) AAU RainSnow, containing videos from traffic intersections under different weather conditions and times; (c) MOT, videos from surveillance cameras in public spaces; (d) VIRAT, also with surveillance videos; (e) DAVIS, containing videos of complex scenes and actions, from which sports videos were selected; and (f) Vimeo90K, also featuring videos of complex scenes and actions, from which animal videos are selected. Among them, only BDD100K has object detection labels, so a quantitative comparison was conducted on it and perform qualitative comparisons across all datasets.

To compare with two-stage methods, the inventors adopted the optimization method GAP-TV, the plug-and-play method PnP-FFDNet, and the state-of-the-art (SOTA) method DEQSCI for video reconstruction using input masks and measurements, followed by object detection with a pre-trained YOLO detector, which is the teacher model in the system of the present invention. For the one-stage method, a baseline model mirroring an architecture similar to FIG. 8 or FIG. 9 may be used, guided solely by the task loss as described earlier.

Consistent with the conventions of SCI, the compression rate of B=8 was adopted to ensure fair comparisons and result reproducibility across methods. Additionally, the memory consumption and inference time were compared, providing a comprehensive analysis of the computational efficiency. An ablation study further explored the impact of compression rates on detection accuracy, offering insights into the interplay between compression and detection precision. Object detection performance is comprehensively measured using 12 metrics, as Table 1 shows. Table 1 shows notations and description of the detection evaluation metrics.

| Notation | Description |
|---|---|
| Average Precision (AP) | |
| AP | AP at IoU = .50:.05:.95 |
| AP^{IoU=.50} | AP at IoU = .50 |
| AP^{IoU=.75} | AP at IoU = .75 |
| AP Across Scales | |
| AP^{small} | AP for small objects: area <32² |
| AP^{medium} | AP for medium objects: 32² < area < 96² |
| AP^{large} | AP for large objects: area >96² |
| Average Recall (AR) | |
| AR^{max=1} | AR given 1 detection per image |
| AR^{max=10} | AR given 10 detections per image |
| AR^{max=100} | AR given 100 detections per image |
| AR Across Scales | |
| AR^{small} | AR for small objects: area <32² |
| AR^{medium} | AR for medium objects: 32² < area < 96² |
| AR^{large} | AR for large objects: area >96² |

Table 2 below shows evaluation of test results of different compared object detection methods on the BDD100K dataset. The term “ours” in the table refers to the method of object detection as described herein in accordance with the invention. For example, method 200 was tested.

As Table 2 shows, the method as per the present invention demonstrates an advancement over others. The average precision (AP) for the method described herein (e.g., method 200, 300) stands at 32.94, which is notably higher than the SOTA two-stage method, DEQSCI, at 26.02, and the one-stage baseline at 26.18. In terms of average recall (AR), the method as per the present invention again outperforms the others indicating superior capability.

| | Strategy | | | | |
|---|---|---|---|---|---|
| | Two-stage | | | | |
| | GAP- | PnP- | | One-stage | |
| Method | TV | FFDnet | DEQSCI | Baseline | Ours |
| Memory (GB) | 1.15 | 6.36 | 5.09 | 4.55 | 4.55 |
| Inference Time | 8449 | 6022 | 3874 | 12 | 12 |
| (ms) | | | | | |

Table 3 above shows a comparison of the complexity of different strategies, where for two-stage methods, videos are reconstructed first and then perform object detection using the pre-trained teacher model. All experiments are conducted on an NVIDIA Geforce RTX 3090 GPU.

Table 3 shows the comparison of computational complexity. While the two-stage strategies require longer inference time, one-stage methods eliminate the requirement of video reconstruction, and thus only cost 12 ms. This drastic difference in inference time elucidates the inherent efficiency of one-stage methods for real-time applications, where rapid processing is paramount.

| Compression Rate | 6 | 8 | 10 | 15 |
|---|---|---|---|---|
| AP | 33.06 | 32.94 | 30.97 | 28.05 |
| AP^{IoU=.50} | 55.59 | 55.30 | 51.33 | 50.60 |
| AP^{IoU=.75} | 33.55 | 33.62 | 30.82 | 27.53 |
| AP^{small} | 16.93 | 16.79 | 15.44 | 13.42 |
| AP^{medium} | 40.04 | 39.52 | 37.22 | 35.55 |
| AP^{large} | 49.50 | 49.15 | 47.99 | 45.05 |
| AR^{max=1} | 23.42 | 23.33 | 22.22 | 20.95 |
| AR^{max=10} | 42.20 | 41.79 | 40.26 | 38.18 |
| AR^{max=100} | 43.92 | 43.52 | 41.91 | 40.07 |
| AR^{small} | 28.00 | 27.85 | 25.18 | 24.64 |
| AR^{medium} | 52.40 | 51.43 | 49.55 | 49.29 |
| AR^{large} | 59.69 | 59.23 | 58.45 | 55.12 |

Table 4 above illustrates the results of the Ablation study varying the compression rate to understand its effect on the efficacy of object detection.

Table 4 explores the impact of compression rates on object detection method according to the present disclosure. As compression rates increase from 6 to 15, a gradual decline in performance metrics is observed. Notably, at a compression rate of 15, which nearly doubles the compression compared to the rate of 8, the method as per the present invention still outperforms the two-stage methods evaluated under a compression rate of B=8, as detailed in Table 2. This finding highlights the superior performance of the method for detecting an object as per the present disclosure.

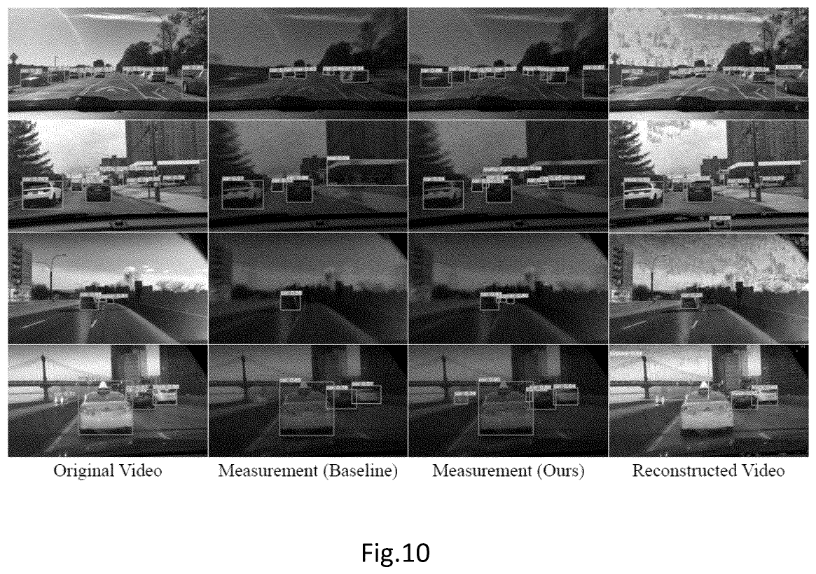

FIGS. 10 to 15 illustrate results on different datasets to facilitate a qualitative comparison. These visualizations intuitively demonstrate the applicability of the method of object detection according to the present invention across a wide range of real-world scenarios. Some example applications will be described with reference to FIGS. 10 to 15.

FIGS. 10 to 15 visualize results on various datasets to encompass a broad spectrum of application scenarios. In all the figures, the first column shows the results on the original video using the teacher model; the last column presents the results on videos reconstructed by DEQSCI. The third column referred to as “Measurement (ours)” shows the performance of the method and system for object detection described herein.

As illustrated in FIG. 10 on real driving videos from the driver's perspective, the method of object detection as per the present invention accurately detects all visible vehicles ahead, whereas both the baseline and two-stage methods exhibit significant misses and false detections. This suggests that described method (or methods) is well-suited for autonomous driving applications.

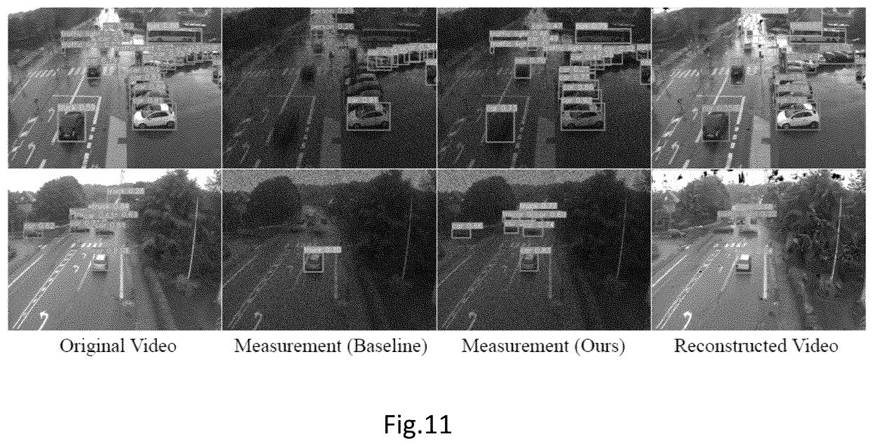

FIG. 11 demonstrates that in surveillance videos from traffic intersections, the results closely mirror those of the teacher model on the original video, even in scenarios where vehicles are densely packed together, as shown in the first row. The baseline and two-stage methods both show noticeable misses and false detections, indicating the superior suitability of method as per the present disclosure for traffic management.

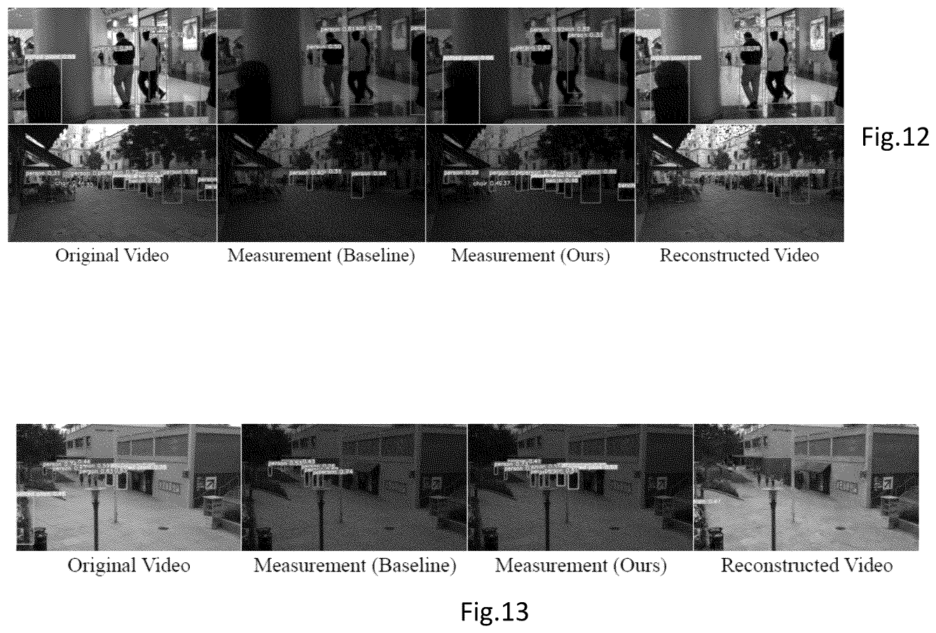

FIG. 12 and FIG. 13 demonstrate that in surveillance videos from public places with pedestrians and facilities. FIG. 12 illustrates qualitative results on the MOT dataset. FIG. 13 illustrates qualitative results on the VIRAT dataset. For both datasets, the method of object detection as described herein performs in line with the teacher model and the original video, while the baseline and two-stage methods suffer misses and false detections. This implies that method as per the present disclosure (e.g., method 200, 300) is suitable for urban surveillance and security applications.

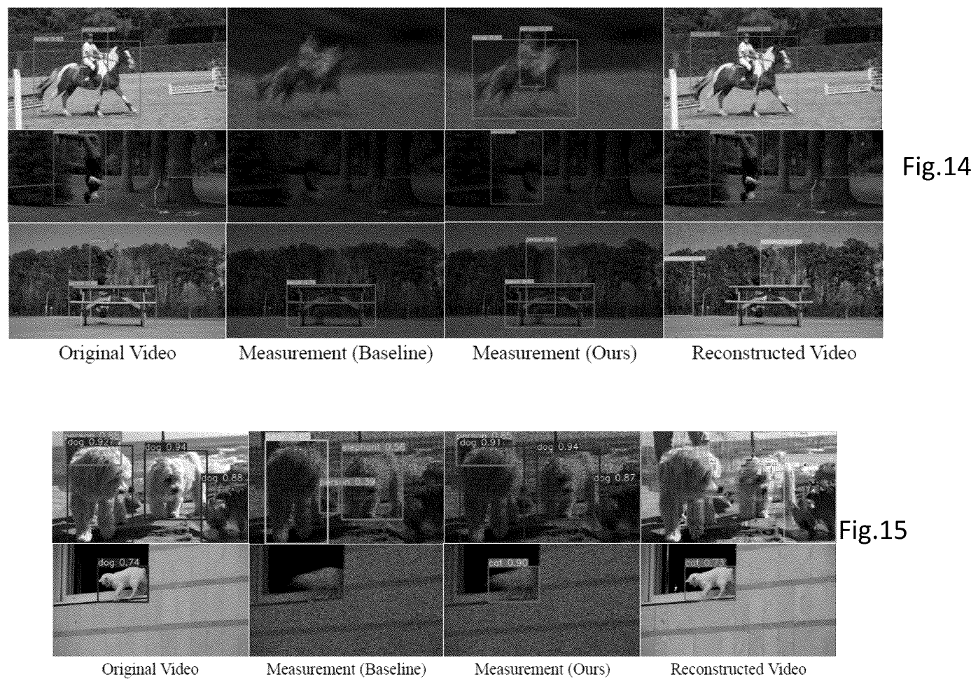

As shown in FIG. 14, in sports videos, the results of the system and method as disclosed herein are nearly identical to those of the teacher model on the original video. Note that in Skate-Jump video shown the third row, even the teacher model does not fully include the person's feet within the prediction box on the original video, whereas the results of the system and method as disclosed more completely predict the entire human body. The baseline often fails to detect any objects, and the two-stage method shows limited performance.

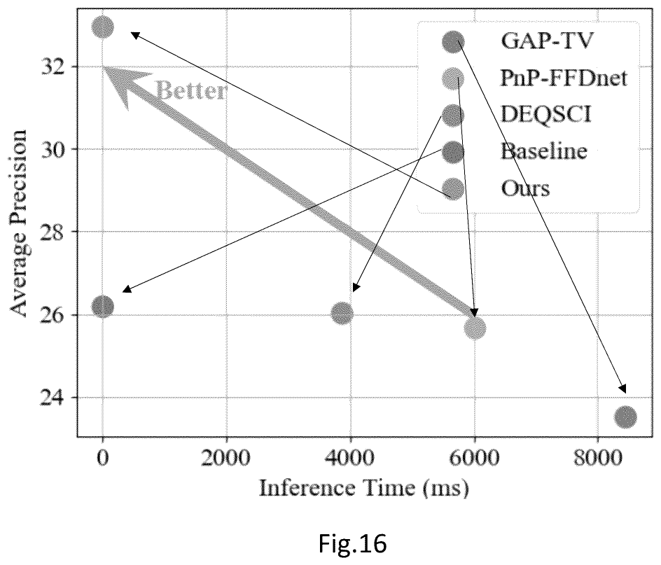

FIG. 15 shows that in animal videos, the results of the method as per the disclosure in the first row (dog videos) closely resemble those of the teacher model on the original video. Interestingly, in the second row's cat video, the teacher model incorrectly identifies the cat as a dog (zoom in to see details), while the method as per the present disclosure correctly classified it. This is most likely because the teacher model predicts frame by frame, and a single video frame offers limited motion information. In contrast, SCI compressed measurements embed more rich object motion information. This indicates the applicability of our method in animal observation, where both the baseline and the two-stage method perform poorly. FIG. 16 illustrates a graph of the comparative performance of the method of object detection as described herein with other object detection methods on various datasets. In particular inference time and average precision was compared. As shown in FIG. 16, the method and system for object detection as described herein performed best.

In one alternative example, the object detection model 124 may include a task aware dynamic mask optimization system or module into the SCI system. The task aware dynamic mask optimization system or module may be integrated into the object detection model 124 architecture. Currently, SCI systems use fixed temporal coding masks. In this alternate example, the system 30 or model 124 may include a feedback mechanism where the object detection performance guides refinement of these temporal coding masks through gradient based optimization. In an alternative example, method 200, 300 may include the further step of refining one or more temporal coding masks based on the performance of object detection. In this example, the detection error may be used to optimize the mask pattern (w) via backpropagation. This may be similar to spirit or neural architecture search but applied to optical sensing or image processing. This implementation of a feedback mechanism forms a co-optimized pipeline (i.e., architecture) for sensing and perception. This is advantageous over the conventional static approach.

In this example, the model 124 architecture are advantageous because the model (and the system utilising the model) jointly optimises compressed domain detection and mask design. In this example the model provides system level synergy as part of the object detection process.

In another example form, the system may be applied as a deployable, online, edge cooperative system that integrates SCI sensing and detection in a closed loop framework. This approach i.e., this example of the system may dynamically adapt the sensing masks in real time based on feedback from the detector. This implementation of the system that integrates SCI sensing and detection may include a failure attention estimator (FAE) that is incorporated or added into a detection module to localize low confidence regions in the compressed input. These regions are fed back to the SCI camera, which reprograms the temporal mask to allocate sensing resources to uncertain areas in the next frame. This process may continue in reinforcement style manner. This example of a system is suitable for edge deployment in real time applications such as smart surveillance or autonomous navigation. This example of a system provides an improved class of task driven compressive sensing with online feedback. This example of the system may be utilised to execute the method for detecting an object (e.g., method 200, 300).

A further alternative form of the system will be described. In conventional SCI systems, the temporal coding masks are fixed once fabricated, and reconstruction and downstream perception (e.g., object detection) are treated as separate steps. In this alternative form, the system embeds a task-aware feedback loop that co-optimizes the mask patterns with object detection performance in mind. In other words, instead of designing a mask solely for generic sparse reconstruction, the mask may be adapted so that objects (e.g., vehicles, pedestrians) are easier to detect once reconstructed—or even directly from compressed measurements—thus forming a closed loop as shown below
Mask Design⇄SCI Acquisition⇄Reconstruction Detection⇄Mask Update

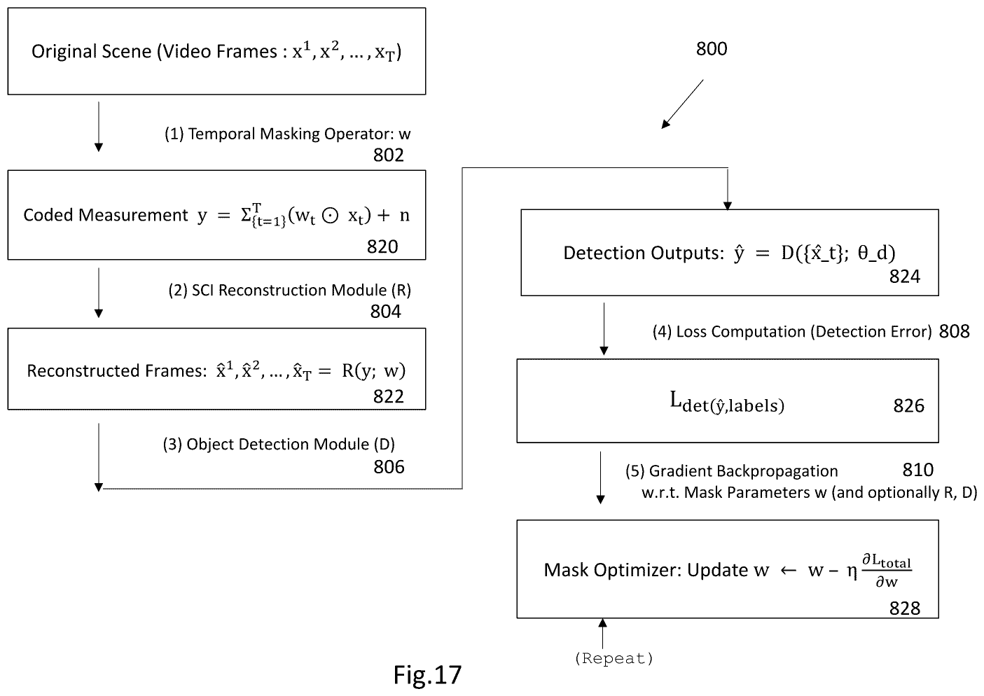

FIG. 17 illustrates an example block diagram of an alternate example of a method for detecting objects. The method may be executed by a system for detecting an object that includes an SCI system, a mask optimizer and a detection system or module. The diagram in FIG. 17 illustrates the data flow and action at each step.

Referring to FIG. 17, at step 802 a temporal masking operator W is applied to the original scene, in particular the video frames of the original scene. The frames may be defined as x¹, x² and so on. Applying the temporal masking operator to the video frames of the original scene generates a coded measurement y=Σ_{{t=1}}^{T}(wₜ⊙xₜ)+n 820. Step 804 comprises applying SCI via an SCI reconstruction module R to output reconstructed frames 822. Object detection 806 may be performed on the reconstructed frames 822. The objection detection step 806 may be performed by an object detection module. The object detection module outputs detection outputs 824. Step 808 comprises performing loss computation (i.e., detection of error). The output of the loss computation is indicated as L_{det(ŷ,labels)} 826. Step 810 comprises gradient backpropagation. Step 810 comprises performing gradient backpropagation with respect to mask parameters W and optionally R, D. The process 800 may be repeated.

In this example, the original scene may comprise a sequence of T high speed frames that a user wishes to capture with single coded snapshot. The mask operator I may be a set of per-timestamped masks {w₁, w₂, . . . , w_{T}}. Each wₜ∈{0,1}ⁿ (or relaxed to [0,1]ⁿ during optimization) encodes that frame. The coded measurement y (820) may be a sensor's 2D measurement, which sums over the masked frames:

$$y = {\sum }_{\{ t = 1 \}}^{T} {w}_{t} ⊙ {x}_{t} + n$$

where “⊙” denotes element-wise multiplication, and n is sensor noise.

The reconstruction module R used in step 804 may be a neural (or model based) network that takes y and (implicitly) the mask w to generate estimates

$${\{ {\hat{x}}_{t} \}}_{t = 1}^{T} .$$

The detection module D used in step 806 may be an object detection network that takes reconstructed frames {\hat{x}ₜ} (or directly y in a compressed-domain variant) and outputs predicted bounding boxes/labels ŷ.

The loss compensation function [symbol] _{det} may be A standard detection loss (e.g., cross-entropy+bounding-box regression loss) comparing y to ground-truth annotations for the frames. The mask optimizer may use gradient signals from the detection loss. The mask optimizer is used to update w so that future measurements y yield reconstructions more conducive to correct detection. Optionally the reconstruction module R and detection network D can be jointly fine tuned. Additionally, because the mask w is typically binary (0 or 1), a differentiable relaxation (e.g., w=σ(u), with u real-valued logits) may be used during optimization; at inference time, w is binarized.

Below is detailed the notation, forward models, loss functions and derivations needed to compute gradients with respect to mask parameters. Below is the notation details.

xₜ∈R^{H×W}: the unknown scene frame at time index t, for t=1, . . . , T. Each frame may be vectorized into R^{N}, where N=H·W.

wₜ∈{0,1}^{H×W} (or relaxed to [0,1]^{H×W}): the binary mask pattern applied to frame xₜ. Typically the following representation may be used wₜ=σ(uₜ) during training, where uₜ∈R^{H×W} are continuous “logit” parameters, and σ(⋅) is the element-wise sigmoid.

y∈R^{H×W}: the single coded measurement formed by summing over masked frames:

$${y}_{i , j} = {\sum }_{t = 1}^{T} {[ {w}_{t} ⊙ {x}_{t} ]}_{i , j} + {n}_{i , j} , ( i , j ) ∈ \{ 1 , … , H \} \times \{ 1 , … , W \}$$

In vector form (flatten frames to length N), the method can define:

$$y = {\sum }_{t = 1}^{T} diag ( {w}_{t} ) {x}_{t} + n ≡ Φ ( w ) X + n$$

$$where :$$

$$X = [ \begin{matrix}{x}_{1} \\ {x}_{2} \\ ⋮ \\ {x}_{T}\end{matrix} ] ∈ {ℝ}^{TN} , Φ ( w ) = [ diag ( {w}_{1} ) diag ( {w}_{2} ) ⋯ diag ( {w}_{T} ) ] ∈ {ℝ}^{N \times ( TN )}$$

R(⋅; w, θᵣ): the reconstruction network (or algorithm) with parameters θᵣ. It takes y and the mask w (i.e., {wₜ}) to produce

$${\{ {\hat{x}}_{t} \}}_{t = 1}^{T} .$$

For notational simplicity, write:

$$[ {\hat{x}}_{1} , {\hat{x}}_{2} , … , {\hat{x}}_{T} ] = R ( y ; w , {θ}_{r} ) ≡ \hat{X} .$$

D(⋅; θ_{d}): the detection network with parameters θ_{d}. It consumes reconstructed frames {\hat{x}ₜ} (or, in a compressed-domain variant, the coded measurement y directly) and outputs predicted bounding boxes and class scores ŷ. Additional definitions are provided below:

$$\hat{y} = D ( \{ {\hat{x}}_{t} \} ; {θ}_{d} ) .$$

[symbol] _{det} (ŷ, y^{gt}): the detection loss (e.g., sum of classification-cross-entropy loss and bounding-box regression loss) comparing y to ground-truth labels y^{gt}.

[symbol] _{recon} (\hat{X},X): (optional) a reconstruction-fidelity loss (e.g., [symbol] ₂ norm) between reconstructed frames \hat{X} and ground-truth frames X.

[symbol] (w): a regularization term on the mask (e.g., [symbol] ₁ sparsity or promoting binary discrete patterns).

The learning rate may be denoted by η, and by θ={θᵣ, θ_{d}} the set of all neural-network parameters. Throughout, the u={u₁, . . . , u_{T}} may be treated as the real-valued logits from which masks are obtained via wₜ=σ(uₜ).

Below is a further derivation of the SCI forward model that may be applied as part of step 800 or may be used in the system 30. In a standard SCI setup, a user may require to capture T consecutive frames x₁, . . . , x_{T} via a single coded snapshot y. Each pixel location (i,j) on the sensor integrates contributions from each frame after element-wise masking:

$${y}_{i , j} = {\sum }_{t = 1}^{T} {w}_{t , i , j} {x}_{t , i , j} + {n}_{i , j} .$$

Vectorizing each frame to xₜ∈ [symbol] ^{N} and stacking into X∈ [symbol] ^{TN}, there is defined: y=Φ(w)X+n, where Φ(w)=[diag(w₁) diag(w₂) . . . diag(w_{T})]∈ [symbol] ^{N×(TN)}.

Here diag(wₜ) is an N×N diagonal matrix whose ith diagonal entry is the ith pixel of mask wₜ. Because masks are binary in hardware, wₜ∈{0,1}^{N}. During training, wₜ=σ(uₜ)∈(0,1)^{N} is relaxed so that gradients can flow.

Additional details of the reconstruction module is provided. The reconstruction module may be provided and used as part of a system for detecting an object. In one example, the reconstruction module may be used as part of system 30. A deep-learning-based reconstruction function R takes y and (implicitly) the knowledge of w (or u) to estimate each frame \hat{x}ₜ. Concretely, one can define:

$$\hat{X} = [ \begin{matrix}{\hat{x}}_{1} \\ {\hat{x}}_{2} \\ ⋮ \\ {\hat{x}}_{T}\end{matrix} ] = R ( y , {\{ {u}_{t} \}}_{t = 1}^{T} ; {θ}_{r} )$$

A typical design is to first “unfold” the measured vector y by using the known mask patterns to form a coarse initial estimate for {xₜ}, then refine via a U-Net or recurrent architecture. For example:

### 1. Initial Linear Inversion:

$${\tilde{X}}^{( 0 )} = {Φ ( w )}^{T} y = [ \begin{matrix}diag ( {w}_{1} ) \\ diag ( {w}_{2} ) \\ ⋮ \\ diag ( {w}_{T} )\end{matrix} ] y = [ {w}_{1} ⊙ y ; {w}_{2} ⊙ y ; … ; {w}_{T} ⊙ y ] ,$$

which “backprojects” the measurement onto each timestamp.

### 2. Deep Refinement:

$$\hat{X} = {F}_{{θ}_{r}} ( {\tilde{X}}^{( 0 )} ) ,$$

where F_{θ}_{ᵣ} is a convolutional or recurrent neural network that outputs \hat{X}=(\hat{x}₁, . . . , \hat{x}_{T}).
During training, Or is learned by minimizing a combined reconstruction+detection loss (see below).

The object detection module D is defined in more detail below.

Once {\hat{x}ₜ} are available, the values are fed into an object detection backbone D(⋅;θ_{d}). For simplicity, let us denote all reconstructed frames concatenated as \hat{X}∈ [symbol] ^{TN}. Then:

$$\hat{y} = D ( \hat{X} ; {θ}_{d} ) ,$$

where ŷ includes predicted bounding-box coordinates and class probabilities for each object in each frame (or a subset of keyframes). If the detection is done on a per-frame basis, then this can be defined as:

$$\hat{y} = {\{ {D}_{t} ( {\hat{x}}_{t} ; {θ}_{d} ) \}}_{t = 1}^{T} ,$$

and the total detection output is the union of per-frame detections.

The loss function formulation is explained below. The loss function may be used in method 800. Optionally, the loss function may be used in the system 30 or in the method 200, 300.

A joint loss is formulated that encourages masks to be optimized so that the final detection performance is maximized. Optionally, a reconstruction fidelity term can be included to ensure that the reconstructed frames remain visually plausible. A typical choice is:

$${ℒ}_{total} = ( u , {θ}_{r} , {θ}_{d} ) = {\underbrace{{ℒ}_{det} ( D ( R ( Φ ( σ ( u ) ) X + n ; σ ( u ) , {θ}_{r} ) ; {θ}_{d} ) , {y}^{gt} )}}_{Dectection Loss} + {λ}_{recon} {\underbrace{{ℒ}_{recon}}}_{Reconstruction Loss ( optional )} ( R ( \cdot ) , X ) + {λ}_{w} ℛ ( σ ( u ) ) .$$

### Here:

$$u = {\{ {u}_{t} \}}_{t = 1}^{T}$$

are the real-valued logit maps for each mask.
σ(uₜ) is the element-wise sigmoid, producing wₜ∈(0,1)^{N}. At inference time, wₜ is binarized by thresholding

$$( e . g . , {w}_{i}^{bin} = 1 \{ σ ( {u}_{t} ) \geq 0.5 \} .$$

λ_{recon} and λ_{w} are hyperparameters.
[symbol] _{recon} (R(⋅),X) is typically

$${‖ \hat{X} - X ‖}_{2}^{2} .$$

[symbol] (σ(u)) is a regularizer on mask values—commonly ∥σ(u)∥₁ to encourage sparsity or a term that encourages binary patterns (e.g.,

$${\sum }_{i , j , t} σ ( {u}_{t , i , j} ) ( 1 - σ ( {u}_{t , i , j} ) ) .$$

Suppose the detection network follows a standard two-stage Faster-R-CNN style or a single-stage YOLO-style architecture. Denote by \hat{p}_{t,k} the predicted class probability vector for bounding box proposal k in frame t, and by \hat{b}_{t,k} its bounding-box coordinates. The ground-truth label for the same is

$$( {p}_{t , k}^{g t} , {b}_{t , k}^{g t} ) .$$

Then:

$${ℒ}_{det} = {\sum }_{t = 1}^{T} {\sum }_{k = 1}^{{K}_{t}} [ - {p}_{t , k}^{g t} \cdot log ( {\hat{p}}_{t , k} ) + α {‖ {\hat{b}}_{t , k} - {b}_{t , k}^{g t} ‖}_{1} ] ,$$

where Kₜ is the number of proposals in frame t, and α balances classification versus regression loss. In practice, one uses the detector's built-in loss (e.g., Smooth L1 for bounding-box regression).

A natural choice is mean-squared error (MSE):

$${ℒ}_{recon} = {\sum }_{t = 1}^{T} {‖ {\hat{x}}_{t} - {x}_{t} ‖}_{2}^{2}$$

In many task-driven scenarios, λ_{recon} is set small or even zero if detection performance alone is the priority.

Mask Regularization [symbol] (w) will now be explained. Since hardware requires binary masks, but learning is supported by a continuous relaxation wₜ=σ(uₜ), outputs close to 0 or 1 are encouraged. A common regularizer is:

$$ℛ ( σ ( u ) ) = {\sum }_{t = 1}^{T} {\sum }_{i = 1}^{N} [ σ ( {u}_{t , i} ) ( 1 - σ ( {u}_{t , i} ) ) ]$$

which achieves its minimum when σ(u_{t,i})∈{0,1}. One can also add an [symbol] ₁ term to control the overall exposure time or brightness:

$${‖ σ ( u ) ‖}_{1} = {\sum }_{t , i} σ ( {u}_{t , i} )$$

The gradient derivation with respect to mask parameters will now be described in more detail. A derivation to compute

$$\frac{\partial {ℒ}_{t otal}}{\partial {u}_{t}}$$

is used so that uₜ (and hence wₜ=σ(uₜ)) can be updated via backpropagation.
1. Forward pass:
   a) Compute wₜ=σ(uₜ).
   b) Form Φ(w) and measurement y=Φ(w)X+n.
   c) Reconstruct \hat{X}=R(y;w,θᵣ).
   d) Detect ŷ=D(\hat{X};θ_{d}).
   e) Compute [symbol] ₜₒₜₐₗ.
2. Backward pass:
   Let:

$${ℒ}_{total} = {\underbrace{{ℒ}_{det} ( \hat{y} , {y}^{gt} )}}_{( A )} + {\underbrace{{λ}_{recon} {ℒ}_{recon} ( \hat{X} , X )}}_{( B )} + {\underbrace{{λ}_{w} ℛ ( σ ( u ) ) .}}_{( C )}$$

Preferably

$$\frac{\partial {ℒ}_{t otal}}{\partial {u}_{t}} .$$

By the chain rule:

$$\frac{\partial {ℒ}_{total}}{\partial {u}_{t}} = {\underbrace{\frac{\partial {ℒ}_{det}}{\partial \hat{y}}}}_{\frac{\partial ( A )}{\partial y}} \cdot {\underbrace{\frac{\partial \hat{y}}{\partial \hat{X}}}}_{D - backprop} \cdot {\underbrace{\frac{\partial \hat{X}}{\partial y}}}_{\frac{\partial R}{\partial y}} \cdot {\underbrace{\frac{\partial y}{\partial {w}_{t}}}}_{\frac{\partial ( ϕ ( w ) X )}{\partial {w}_{t}}} \cdot \frac{\partial {w}_{t}}{\partial {u}_{t}} + {\underbrace{{λ}_{recon} \cdot \frac{\partial {ℒ}_{recon}}{\partial \hat{X}}}}_{term ( B ) yields \partial \hat{X}} \cdot {\underbrace{\frac{\partial \hat{X}}{\partial y}}}_{\frac{\partial R}{\partial y}} \cdot {\underbrace{\frac{\partial y}{\partial {w}_{t}}}}_{\frac{\partial ( ϕ ( w ) X )}{\partial {w}_{t}}} \cdot \frac{\partial {w}_{t}}{\partial {u}_{t}} + {\underbrace{{λ}_{w} \frac{\partial ℛ ( σ ( {u}_{t} ) )}{\partial {u}_{t}}}}_{( C ) direct regularization}$$

Each factor is discussed below:

$$3. \frac{\partial y}{\partial {w}_{t}} :$$

Recall

$$y = {\sum }_{t = 1}^{T}$$

wₜ⊙xₜ. Hence,

$$\frac{\partial {y}_{i}}{\partial {w}_{t , j}} = \frac{\partial }{\partial {w}_{t , j}} ( {\sum }_{{t}^{′} = 1}^{T} {w}_{{t}^{′} , i} {x}_{{t}^{′} , i} ) = \{ \begin{matrix}{x}_{t , i} , & if i = j \\ 0 , & otherwise\end{matrix}$$

In vector form:

$$\frac{\partial y}{\partial {w}_{t}} = {x}_{t} ∈ {ℝ}^{N} ,$$

which is the element-wise product assumption.
More formally,

$$\frac{\partial Φ ( w ) X}{\partial {w}_{t}} = diag ( {x}_{t} ) ,$$

so the Jacobian maps changes in wₜ to changes in y.

$$4. \frac{\partial \hat{X}}{\partial y} :$$

The reconstruction network R(⋅) is differentiable, so one computes

$$\frac{\partial \hat{X}}{\partial y} = {J}_{R} ( y ; w , {θ}_{r} ) ∈ {ℝ}^{( TN ) \times N} ,$$

i.e., the Jacobian of R w.r.t. its input y. It can be obtained by backpropagating through the layers of R.

$$5. \frac{\partial \hat{y}}{\partial \hat{X}} :$$

The detection network D(⋅) is likewise differentiable. Its Jacobian J_{D}(\hat{X};θ_{d})∈ [symbol] ^{|ŷ|×(TN)} is obtained via backprop through D.

$$6. \frac{\partial {w}_{t}}{\partial {u}_{t}} :$$

Since wₜ=σ(uₜ), element-wise, results in

$$\frac{\partial {w}_{t , i}}{\partial {u}_{t , i}} = σ ( {u}_{t , i} ) ( 1 - σ ( {u}_{t , i} ) ) = {w}_{t , i} ( 1 - {w}_{t , i} ) .$$

Thus diag(wₜ⊙(1−wₜ)) is the Jacobian of wₜ w.r.t. uₜ.
7. Regularization term

$$\frac{\partial ℛ ( σ ( {u}_{t} ) )}{\partial {u}_{t}} :$$

$$For ℛ ( w ) = {\sum }_{i = 1}^{N} {w}_{t , i} ( 1 - {w}_{t , i} ) ,$$

$$\frac{\partial ℛ}{\partial {w}_{t , i}} = 1 - 2 {w}_{t , i} , \frac{\partial {w}_{t , i}}{\partial {u}_{t , i}} = {w}_{t , i} ( 1 - {W}_{t , i} ) .$$

$$Hence ,$$

$$\frac{\partial ℛ}{\partial {u}_{t , i}} = ( 1 - 2 {w}_{t , i} ) {W}_{t , i} ( 1 - {W}_{t , i} ) .$$

Putting these factors together, the full gradient w.r.t. each pixel of uₜ is given by:

$$\frac{\partial {ℒ}_{total}}{\partial {u}_{t , i}} = {\underbrace{[ {\underbrace{\frac{\partial {ℒ}_{det}}{\partial \hat{y}} {J}_{D}}}_{( A )} + {λ}_{recon} {\underbrace{\frac{\partial {ℒ}_{recon}}{\partial \hat{X}} {J}_{R}}}_{( B )} ]}}_{Gradient at \hat{X} , backprop to y} \times {\underbrace{{x}_{t , i}}}_{\partial {y}_{i} / \partial {w}_{t , i}} \times {\underbrace{{w}_{t , i} ( 1 - {w}_{t , i} )}}_{\partial {w}_{t , i} / \partial {u}_{t , i}} + {λ}_{w} ( 1 - 2 {w}_{t , i} ) {w}_{t , i} ( 1 - {w}_{t , i} ) .$$

In matrix notation, letting

$${δ}^{( D )} = {J}_{D}^{⊤} ( \partial {ℒ}_{det} / \partial \hat{y} ) ∈ {ℝ}^{TN} and {δ}^{( R )} = {J}_{R}^{⊤} ( \partial {ℒ}_{recon} / \partial \hat{X} ) ∈ {ℝ}^{TN} ,$$

for each timestamp t:

$$\frac{\partial {ℒ}_{total}}{\partial {u}_{t}} = [ {( {δ}^{( D )} + {λ}_{recon} {δ}^{( R )} )}_{t} ⊙ {x}_{t} ] [ {w}_{t} ( 1 - {w}_{t} ) ] + {λ}_{w} ( 1 - 2 {w}_{t} ) [ {w}_{t} ( 1 - {w}_{t} ) ]$$

Here (δ^{(D)})ₜ∈ [symbol] ^{N} denotes the slice of δ^{(D)} corresponding to frame t. In practice, λ_{recon} can be set to zero If detection performance was considered; then terms from δ^{(R)} vanish.

The mask optimizer 828 may perform or apply an optimization algorithm. The following variables are jointly optimized:
Mask logits uₜ
Reconstruction parameters θᵣ (optionally)
Detection parameters θ_{d} (optionally; often pre-trained and fixed)

Typical training loop (per mini-batch of video clips and annotations) is explained below. The training loop may be applied to train the model 124 in one example. Alternatively, the training loop may be applied to train the system and/or parts of the system for detecting an object.
1. Forward: Given X (true frames) and current mask logits {uₜ}:
   i. Compute wₜ=σ(uₜ).
   ii. Compute coded measurement y=Σₜ wₜ⊙xₜ+n.
   iii. Reconstruct \hat{X}=R(y;w,θᵣ).
   iv. Detect ŷ=D(\hat{X};θ_{d}).
   v. Compute [symbol] ₜₒₜₐₗ.
2. Backward: Compute gradients w.r.t. θᵣ, θ_{d}, and u, as outlined above.
3. Update:

$${θ}_{r} ← {θ}_{r} - {η}_{r} \frac{\partial {ℒ}_{total}}{\partial {θ}_{r}} , {θ}_{d} ← {θ}_{d} - {η}_{d} \frac{\partial {ℒ}_{total}}{\partial {θ}_{d}} , {u}_{t} ← {u}_{t} - {η}_{u} \frac{\partial {ℒ}_{total}}{\partial {u}_{t}} .$$

4. Binarization (at inference): After training, each threshold may be defined as wₜ=σ(uₜ) at 0.5 to obtain binary masks

$${w}_{t}^{bin} .$$

Those are fabricated onto the DMD or SLM.

The method disclosed in FIG. 13 may be applied by a system 30. The derivations described above and the components may be used in the system 30.

In an alternative example the system may include additional features such as the loss computation module, and mask optimizer as disclosed above.

The methods for object detection may introduce a new feedback loop that drives mask design based on detection error, thereby enabling sensing perception. By parameterizing the binary mask as wₜ=σ(uₜ) and including a regularizer [symbol] (w) that encourages binarization, gradients from detection (and optional reconstruction) losses are allowed to flow back through the coding stage. This yields a continuous-to-discrete pipeline: train in the continuous domain, then threshold for hardware implementation.

Unlike standard SCI pipelines that treat reconstruction and downstream tasks separately (e.g., reconstruct first, then detect), the system (i.e., framework) as disclosed herein allows optional joint fine-tuning of the reconstruction network R and detection network D alongside mask adaptation. This co-optimization improves synergy between all stages.

The present invention introduces an improved paradigm that departs from the conventional detection-after reconstruction methods. The present invention involves the direct object detection from compressed optical measurements i.e., compressed images. Employing knowledge distillation with a pre-trained object detection model and a well designed combination of feature loss and task loss in the training strategy of the object detection model 124, the method of object detection described herein demonstrates superior performance across multiple datasets, as shown in FIG. 16.

The system and method for detecting an object from one or more images as described herein, represents a paradigm shift that accelerates processing and enhances outcomes directly from compressed measurements, circumventing the need for full reconstruction.

The method and system described herein extends the capabilities of SCI to pave the way for AI and imaging in real-time applications, particularly in domains where the rapid capture and detection of moving objects are paramount, such as autonomous driving, urban surveillance, sports analytics, and animal monitoring. The method and system described provides improved accuracy of object detection, reduced processing times and reduced computing resources, as compared to other object detection methods. The test results further prove the superior performance of the method and system as described herein.

The system for detecting an object from one or more images 30 (i.e., a system for object detection) as described herein, is advantageous since the system performs object detection directly on optically compressed images acquired using an SCI system. The system 30 does not rely on motion vectors or frame decompression. The system 30 is advantageous because the architecture is trained via knowledge distillation to detect objects directly in a compressed image eliminating the reconstruction stage. The system 30 uses a teacher model to train a student model to perform object detection. The student model is trained to detect objects directly from compressed optical measurements produced by a SCI system. The knowledge distillation may be directly integrated into the student model to enhance detection on compressed SCI image data.

The system and method for detecting an object as described herein, are advantageous because the system and method perform object detection directly from compressed images i.e., without reconstructing the images. The system 30 and method 200, 300 are also advantageous since the system and method does not require background removal or augmentation techniques in image processing. Instead the system and method address the problem of bounding box object detection directly on raw compressed images (i.e. compressed optical signals) using a YOLO architecture trained model (e.g., the student model). The student model utilises a YOLO architecture and includes knowledge distillation by training the student model by a teacher model, and the student model is specifically optimised for processing SCI compressed images.

The system is advantageous it leverages an SCI system as the image acquisition rather than conventional video formats. This enables compressed sensing at the optical level. This allows sensing of fast moving objects. The system and method for detecting an object are advantageous because the computationally expensive image reconstruction stage is bypassed and objects are detected directly in the compressed images.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present invention are either wholly implemented by computing system or partly implemented by computing systems then any appropriate computing system architecture may be utilised. This will include standalone computers, network computers and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc., in a computer program. When a process corresponds to a function, its termination corresponds to a return of the function to the calling function or a main function.

1. A system for detecting an object from an image comprising:
a computing apparatus comprising a processing unit, a memory unit and a user interface, the processing unit operatively coupled to the memory unit,
the computing apparatus is configured to:
receive one or more images of a real-world scene,
compress the one or more received images to obtain one or more compressed images,
detect one or more objects in each compressed image, and;
present the one or more detected objects on a user interface.

2. The system of claim 1 wherein the computing apparatus is adapted to perform an object detection process directly on the compressed images to detect the one or more objects.

3. The system of claim 2 wherein the computing apparatus comprises an object detection model stored therein, wherein the computing apparatus is configured to apply the object detection model to the received images as part of the object detection process.

4. The system of claim 3 wherein the object detection model comprises a backbone feature module and a task loss module and feature loss module.

5. The system of claim 1 wherein the computing apparatus is configured to compress the received images using a Snapshot Compressive Imaging (SCI) system.

6. The system of claim 5 wherein the computing apparatus is configured to encode the received images by temporally varying masks as part of compressing the one or more received images.

7. The system of claim 3 wherein the object detection model comprises a pre trained YOLO model.

8. The system of claim 7 wherein the object detection model comprises an encoder, convolution layers, a backbone feature, neck and head, wherein neck and head output an image with detected objects identified thereon.

9. The system of claim 8 wherein the object detection model is trained using a knowledge distillation process executed by the computing apparatus.

10. The system of claim of claim 8 wherein computing apparatus is configured to, as part of the knowledge distillation process:
build a teacher model configured to extract and utilize visual information from ground truth images or videos,
guide a student model using the teacher model to train the student model to detect objects, wherein the student model is the object detection model, and;
wherein the teacher model and the student model are adapted to utilize a combined feature loss and task loss.

11. The system of claim 1 wherein the one or more images are still images or frames of a video stream.

12. A system for detecting an object from an image comprising:
a computing apparatus comprising a processing unit, a memory unit and a user interface, the processing unit operatively coupled to the memory unit,
the computing apparatus is configured to:
compress optical signals (i.e., visual signals) from a real world scene using a Snapshot Compressive Imaging (SCI) system to obtain compressed signals,
receive the compressed signals,
store the compressed signals as compressed images,
apply one or more knowledge distillation techniques in conjunction with a pre trained object detection model to detect one or more objects directly from each compressed image,
utilise motion information encoded within the compressed data to optimise the object detection process,
present on the user interface the one or more detected objects on an image.

13. The system for detecting an object of claim 12, wherein the computing apparatus is configured to capture images using a snapshot compressive imaging (SCI) system, wherein the SCI system is configured to capture images and compress the images to generate the one or more compressed images.

14. The system for detecting an object of claim 13, wherein the computing apparatus may be configured to apply an object detection model, wherein the object detection model is arranged to be trained by using the knowledge distillation process in conjunction with a pre trained model; and the pre trained model is arranged to operate as a teacher model to train the object detection model.

15. The system for detecting an object of claim 14, wherein the pretrained student model may be a YOLO model.

16. The system for detecting an object of claim 14, the one or more objects are detected directly in each compressed image, wherein the one or more objects are detected in each compressed image without first decompressing or reconstructing the images.

17. The system for detecting an object of claim 16, wherein the object detection model comprises a feature loss module and a task loss module, and the object detection model comprises an encoder, convolution layers, a backbone feature, neck and head, wherein neck and head output an image with detected objects identified thereon.

18. The system for detecting an object of claim 14, the object detection model is trained to identify objects and perform feature extraction from compressed images.

19. A method for detecting an object comprising the steps of:
receiving one or more images of a real-world scene,
compressing the one or more received images to obtain one or more compressed images, wherein compressing comprises applying a snapshot compressive imaging (SCI) system to compress the received images,
wherein compressing the images further comprises encoding the received images by temporally varying masks,
detecting one or more objects directly in each compressed image,
presenting the one or more detected objects on a user interface,
wherein detecting one or more objects comprises applying an object detection model to the received images, wherein the object detection model comprises a backbone feature module and a task loss module and feature loss module,
wherein the object detection model is a pretrained YOLO model, and wherein the YOLO model is pretrained to detect objects directly in each compressed image.

20. The method of claim 15, employing a combination of feature loss and task loss in the training strategy of the detection model, which is arranged to enhance the performance of object detection algorithms that work directly with compressed optical measurements, and wherein the training strategy is arranged to align with real-time application requirements to overcome limitations associated with traditional methods that require decompression or reconstruction of data before detection can occur.
